(19) United States
(12) Patent Application Publication
(10) Pub. No.: US 2008/0245436 A1
(43) Pub. Date: Oct. 9, 2008

(54) Beverage dispenser with apparatus for lifting and transferring loads

(76) Inventor: Duane Lang, Tyler, TX (US)

Correspondence Address: Duane Lang, P.O. Box 4124, Tyler, TX, 75712, US

(21) Appl. No.: 11/784,483

(22) Filed: Apr. 6, 2007

(51) Int. Cl. B65D 21/02; B67D 5/00

(52) U.S. Cl. 141/2; 222/165

(57) ABSTRACT

An apparatus for lifting a load and transferring the load to an inverted orientation for placement includes a fixed frame, a first moveable frame slidably connected to the fixed frame to move longitudinally relative thereto, a second moveable frame sidably connected to the first moveable frame to move longitudinally relative thereto upon movement of the first moveable frame relative to the fixed frame, and a load platform pivotally connected to the second moveable frame so as to allow rotation of the load platform and a load carried thereon so as to invert the orientation of the load. In a preferred embodiment the apparatus for lifting and transferring is integrated with a beverage dispenser for lifting a large water bottle to the top of the dispenser, and inverting and placing the water bottle on the dispenser for use. In another embodiment a mobile lifting apparatus is provided.

### FIELD OF THE INVENTION

The present invention generally relates to load transporting and transferring apparatus, and in its preferred embodiments more specifically relates to an apparatus for lifting and transferring water bottles, integrated with a beverage dispenser.

### BACKGROUND OF THE INVENTION

Hand trucks and dollies are very useful devices for transporting heavy or bulky loads from one place to another, and greatly facilitate the movement of loads along the ground or along a floor surface. Once the load has been transported to a location for storage or use, however, it must be moved from the hand truck and often must be lifted to a position above the carrying platform of the hand truck. The placement of full water bottles in an inverted position in the top of a water dispensing cabinet is one specific example of such a situation. Water dispensers are commonly used in both home and business settings, and users are often required to lift a large, heavy, open bottle of water from the floor to place it in an inverted position on the cabinet, with the open mouth of the bottle extending downward in an opening at the top of the cabinet.

The prior art includes hand trucks with various types of lifting mechanisms, for raising the load platform and or the object transported on it to a higher elevation so that the load can be more easily placed in a final position. In all hand trucks with lifting mechanisms known in the prior art, however, the lifting mechanism is elevating the load platform through only a portion of the height of the upright framework of the truck, so that the upright framework prevents movement of the load to the rear of the truck over the upright framework. In all prior art mechanisms the load is moved off the load platform by sliding the load directly forward, and rotating the load to invert it during the removal process is difficult or impossible.

In some situations the inability to rotate the load while it is still carried by the truck is problematic. In the instance of a beverage dispenser for dispensing water and other water-based beverages, when water bottles are loaded into the dispenser the bottles must be inverted, so that the neck of the bottle can be inserted into the top of the dispenser cabinet. Many people who use such beverage dispensers are not accustomed to lifting and manipulating heavy loads, and do not have the physical strength to lift and turn a full bottle to insert it into a dispenser. Even those who have the physical strength may loose control of a bulky as well as heavy water bottle while attempting to load it into the dispenser cabinet.

### SUMMARY OF THE INVENTION

The present invention addresses the problem and the deficiencies of the prior art by providing, in its preferred embodiment, a beverage dispenser with an integral, preferably motor driven, lifting mechanism that allows a water bottle to be lifted from the floor to the top of the dispenser in an upright orientation, and them smoothly inverted and simultaneously moved over the opening in the top of the dispenser cabinet for placement in the dispenser. In the preferred embodiment the drive motor is disposed within the structure of the cabinet and the lifting mechanism is disposed closely against one side wall of the cabinet to minimize the outward extension of the lifting mechanism from the cabinet and thus minimize the total floor space required. The lifting mechanism includes a pivoting load platform to support a water bottle while it is lifted vertically as well as while it is rotated to an inverted orientation and translated sideways over the top of the cabinet for insertion.

In another embodiment the invention provides a moveable hand truck with a load platform that can be raised sufficiently relative to the upright framework of the truck to clear the upper portion of that upright frame, and with a pivoting load platform to allow the load to be rotated over the upright frame of the truck. The load platform of the apparatus of the invention will pivot sufficiently to completely invert the load over the top of the upright frame, and can be pivoted to any intermediate position. The hand truck embodiment of the invention is particularly well suited to use for transporting a full water bottle to a conventional beverage dispenser, raising the water bottle to the height of the top of the cabinet, and rotating the bottle and load platform to invert the bottle and position it with the neck of the bottle received in the top of the cabinet. In an alternative embodiment the pivoting lift mechanism of the invention may be provided as a unit that can be attached to an conventional dispenser cabinet, for safely and easily lifting and turning full water bottles for insertion into the top of the cabinet.

The structure and features of preferred and alternative embodiments of the apparatus of the invention will be described in detail below, with reference to the accompanying drawing figures.

### BRIEF DESCRIPTION OF THE DRAWINGS

FIG. 1 is a front elevation view of a preferred embodiment of the integrated apparatus of the invention, with load platform and load in a lowered position, and with a bottle in place on the load platform.

FIG. 2 is a side elevation view of a preferred embodiment of the integrated apparatus of the invention, in the lowered position of FIG. 1, with the load platform removed for clarity.

FIG. 3 is a partially cut-away top plan view of a preferred embodiment of the integrated apparatus of the invention.

FIG. 4 is a partially cut-away front elevation view of a preferred embodiment of the integrated apparatus of the invention, in the lowered position.

FIG. 5 is a front elevation view of a preferred embodiment of the integrated apparatus of the invention, with the load platform and load in an intermediate position, showing some internal components of the apparatus through the structure, for orientation.

FIG. 6 is a front elevation view of a preferred embodiment of the integrated apparatus of the invention, with the load platform and load in a fully elevated, upright position, showing some internal components of the apparatus through the structure, for orientation.

FIG. 7 is a front elevation view of a preferred embodiment of the integrated apparatus of the invention, with the load platform and load in a fully elevated, partially rotated position.

FIG. 8 is a side elevation view of an alternative embodiment of a manually operated mobile lifting and transferring apparatus of the invention, with the load platform and load in a fully elevated, partially rotated position.

FIG. 9 is a front elevation view of the alternative embodiment as shown in FIG. 8.

FIG. 10 is a front elevation view of an alternative embodiment of a motor operated mobile lifting and transferring apparatus of the invention, with the load platform and load in the lowered position, and with components shown as transparent so as to show all components.

FIG. 11 is a top plan view of an embodiment of the load platform component, with a curved rear wall and support wall.

FIG. 12 is a top plan view of another embodiment of the load platform component, with planar rear and support walls.

FIG. 13 is a schematic illustration of the motor control system of a preferred embodiment of the apparatus of the invention, showing an upright channel of the fixed frame, a motor, a switch, and upper and lower limit switches.

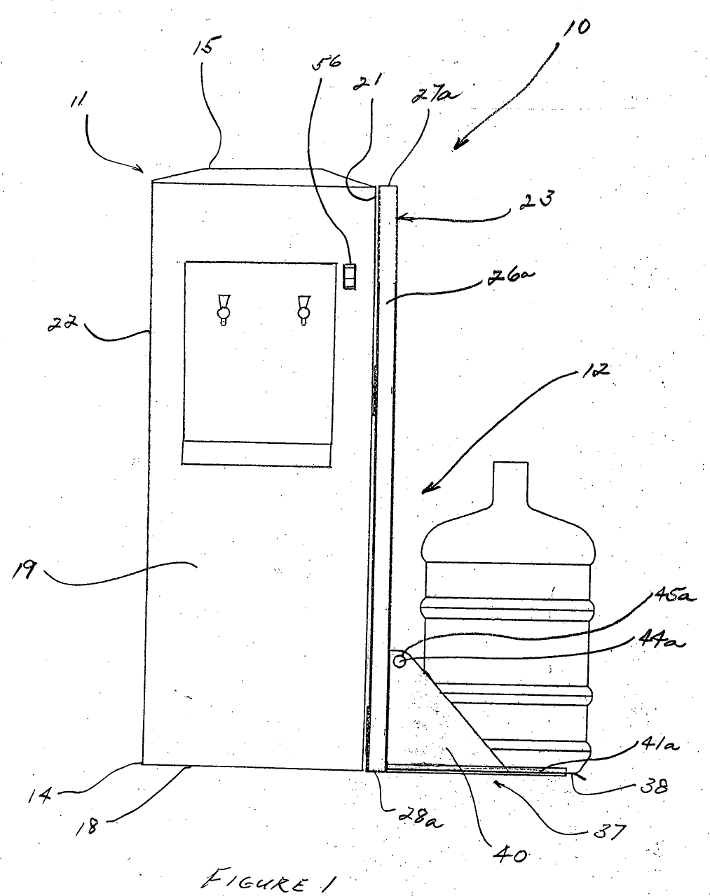

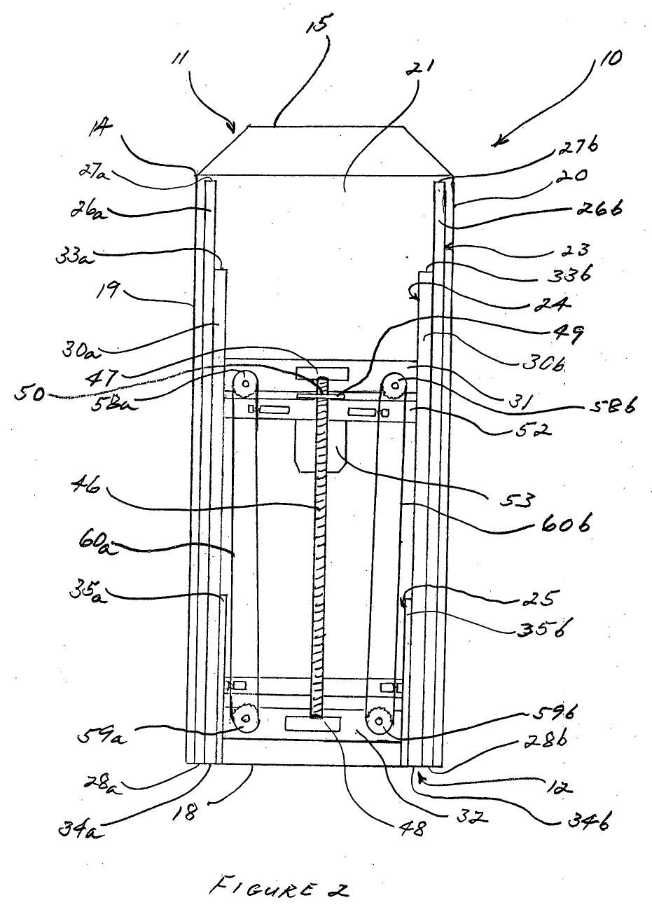

### DESCRIPTION OF THE INVENTION

Referring now to the drawing figures, the preferred embodiment of the apparatus of the invention, generally identified by reference number 10, comprises a beverage dispenser unit 11 and a lifting assembly 12. Dispenser unit 11 includes a structural frame 13 and an outer housing 14, enclosing the structural frame and the beverage preparation and dispensing equipment disposed within the housing and connected to the structural frame, as well as enclosing open space within the housing. Housing 14 includes a top 15 with an opening 16 to receive the neck of an inverted water bottle, and a seating ring 17 surrounding opening 16 and upon which the shoulder of a water bottle rests when the bottle is in place on the dispensing unit. Housing 14 also includes a bottom 18, a front panel 19, a rear panel 20, a first side panel 21, and a second side panel 22, opposite side panel 21. The front, rear, and side panels may be individually formed or formed as an integral unit, and the specific construction is not material to the scope of the invention.

In the preferred embodiment of the invention, lifting assembly 12 comprises a three part frame including a fixed frame 23, a first moveable frame 24, and a second moveable frame 25. The fixed frame includes a pair of upright channels 26, disposed in parallel, generally upright or vertical orientation, and designated as 26a and 26b on opposite sides of the frame. Each of channels 26 has a first, upper end 27 and a second, lower end 28, further identified by “a” and “b”, respectively. Channels 26a and 26b are preferably “C” channels, each having three walls surrounding an open interior, disposed with the open sides of the channels facing each other from either side of the fixed frame. Attachment brackets 29 are connected to upright channels 26 and extend outwardly therefrom generally perpendicular to the longitudinal axis of the channels, and are used as needed for connecting the lifting assembly to a dispenser unit. The use and placement of attachment brackets will depend upon the structure of dispenser frame 13 and the position of channels 26 relative to structural members forming frame 13. In the preferred embodiment one set of attachment brackets is disposed adjacent to upper ends 27 of channels 26 and a second set is disposed adjacent to lower ends 28, for connecting the fixed frame at top and bottom to the dispenser unit. Although the structure described above is the preferred embodiment of the fixed frame, it is to be understood that the scope of the invention is not limited to that particular structure. Other frame structures may be used, so long as the upright channels for the first moveable frame are included. It is also preferred that the fixed frame structure not extend above the upper ends of those channels, and that the fixed frame structure avoid interference with the load through the range of motion described below.

It is preferred that fixed frame 23 be positioned as closely to the beverage dispenser as possible, to minimize the extension of the lifting mechanism outwardly from the dispenser housing and to maintain as much stability as possible when a full water bottle is lifted upwardly along one side of the dispenser. In a particularly preferred embodiment, in which the lifting mechanism is fully integrated with the dispenser, upright channels 26 are nested within the dispenser housing, and the associated side panel of the dispenser either recessed or slotted to accommodate the upright channels within the footprint of the dispenser. Attachment brackets 29 disposed at the lower ends 28 of channels 26 may be extended outwardly from the side panel of the dispenser to effectively widen the footprint of the apparatus and provide support directly under the lifting mechanism.

First moveable frame 24 includes a pair of upright channels 30a and 30b, nested within upright channels 26a and 26b, respectively, in longitudinal sliding relation therewith. Each of channels 30a and 30b is preferably formed as a “C” channel, with their open sides facing each other. An upper horizontal plate 31 and a lower horizontal plate 32 extend between channels 30a and 30b and are connected thereto with plate 31 positioned downward from the upper ends 33a and 33b of channels 30a and 30b, and with plate 32 positioned near the lower ends 34a and 34b of those channels. The connection between the horizontal plates and the upright channels of the first moveable frame are made such that the plates do not extend into the open interior of those channels. The length of channels 30a and 30b are equal, and less than the lengths of channels 26a and 26b. Generally, channels 30 are within the range of two-thirds to three-fourths the length of channels 26.

Second moveable frame 25 includes a pair of upright members 35a and 35b, nested within upright channels 30a and 30b, respectively, of the first moveable frame, in longitudinal sliding relation. Members 35a and 35b may be formed as “C” channels, but it is preferred that they be formed with a square or rectangular cross-sectional configuration for strength and stability. At least one horizontal member 36 is preferably connected between members 35a and 35b, at or adjacent to their lower ends.

Load platform 37 is connected to second moveable frame 25 to move with that frame, and is effectively a part of that structure. Load platform 37 includes a generally flat base 38, preferably formed with a semi-circular curvature at its rear edge 39, and a curved support wall 40 connected to the base at its rear edge 39 and at least partially along side edges 41a and 41b and extending upwardly generally parallel to the base. Alternatively, load platform 37 may be formed with base 38 in a generally rectangular configuration, with a generally rectangular base 38 and rear wall 42 and with planar side supports 43a and 43b, preferably of generally triangular configuration, connected between base 37 and rear wall 42, with the side supports in parallel relation to each other. The load platform is pivotally interconnected to second moveable frame near the upper edge of support wall 40, or rear wall 42 in the alternative embodiment, preferably by pivot pins ⁴4a and 44b through pin apertures 45a and 45b in curved support 40, or alternatively in side supports 43a and 43b and connecting to upright members 35a and 35b of the second moveable frame without extending across that frame, so that the space between the upright members of the second moveable frame is substantially open above horizontal member 36. The supporting wall structure of the preferred and alternative structures described above is provided for the purpose of stabilizing a water bottle on the load platform, but it is to be understood that such supporting structure could be omitted entirely, if desired, although with an increased risk of loss of control of the bottle during use of the apparatus.

In order to minimize the footprint of the apparatus when the lifting mechanism is not in use, an alternative foldable load platform may be utilized. In this embodiment, rectangular base 38 may be divided into two portions, connected by hinges, so that the major portion of the load platform can be pivoted upwardly to lie parallel to the upright frame members of the structure. Side supports 43 may also each be divided into two portions, connected by hinges, so that the major portion of the side supports can be pivoted inwardly to a mutually parallel orientation parallel to the hinged portion of base 38.

The first moveable frame is actuated to move relative to the fixed frame by a first or primary lift means that preferably includes an elongate threaded rod 46, extending parallel to and generally centered between upright channels 30a and 30b of the first moveable frame, and fixedly connected to horizontal braces 31 and 32 of that frame, preferably by thrust connectors 47 and 48, respectively, that prevent movement of the rod relative to the braces. A primary chain sprocket 49 with a threaded central aperture 50 is threaded onto rod 46 and disposed on rod 46 between bearings 47 and 48. Sprocket 49 is connected to a horizontal bracket 51 that is connected between upright channels 26a and 26b of fixed frame 23. Bracket 51 is connected to the fixed frame so as to avoid interference with the movement of either first moveable frame 24 or second moveable frame 25. Sprocket 49 is connected to bracket 51 by a rotational bearing 52 that allows rotation of the sprocket in the bearing without separation of the sprocket from the bracket.

Sprocket 49 is caused to rotate by, preferably, electric motor 53, which is preferably mounted to frame 13 of dispenser 11 within housing 14 with the output shaft 54of the motor disposed parallel to rod 46. Drive sprocket 55 is connected to the output shaft of the motor, which is disposed such that sprocket 55 is positioned in the same plane as sprocket 49. The beverage dispenser components themselves typically require very little of the space available within housing 14, leaving ample space for the placement of motor 53, allowing a range of choices for the disposition of the motor within the dispenser housing. As the position of motor 53 is varied, the placement of bracket 51 and sprocket 49 will vary accordingly. Motor 53 is preferably connected to the beverage dispenser electrical wiring, and is actuated by a primary switch 56 disposed in any convenient location on housing 14. A looped drive chain 57 is engaged around sprockets 49 and 55, so that rotation of sprocket 55 caused by activation of the motor results in rotation of sprocket 49. When sprocket 49 is rotated, the threaded engagement between sprocket 49 and rod 46 causes rod 46 to move up or down, depending on the direction of rotation, relative to sprocket 49. Movement of rod 46 results in movement of the first moveable frame, to which rod 46 is connected, in channels of the fixed frame.

The-apparatus of the invention is designed and constructed so that movement of the first moveable frame relative to the fixed frame causes the second moveable frame, and the attached load platform, to also move relative to the first moveable frame. Movement of the second moveable frame is accomplished by a secondary chain drive, which includes a pair of secondary drive upper sprockets 58a and 58 b, pivotally connected to upper horizontal brace 3 1 of the first moveable frame near the respective ends of that brace on the opposite side of the brace from rod 46. Similarly, secondary drive lower sprockets 59a and 59b are pivotally connected to lower horizontal brace 32, in vertical alignment with sprockets 58a and 58b . The sprockets are connected to the horizontal braces so that the sprockets are spaced a short distance forward of the braces, and the plane of rotation of the sprockets is parallel to the plane of those horizontal braces. Chains 60a and 60b are looped around sprockets 58a and 59a , and 58b and 59b , respectively.

Chain 60a is connected to the fixed frame of the apparatus at one point, or along a short length of the chain, adjacent to and slightly below upper sprocket 58a , preferably in the portion of the chain loop nearest to that side of the fixed frame. Similarly, chain 60b is connected to the fixed frame in mirrored relation to the connection of chain 60a. As a result, chains 60a and 60b are constrained at the points of connection against movement relative to the fixed frame.

The second moveable frame is connected to each of chains 60a and 60b adjacent to lower sprockets 59a and 59b , in the opposite portion of the chain loops from the connections between the chains and the fixed frame. This connection may also be made between the chains and a component of the load platform, if desired, since the load platform and the second moveable frame and connected to each other and move together. Because the chains are fixed in position relative to the fixed frame and load platform, when motor 53 is activated to lift the first moveable frame relative to the fixed frame, sprocket sets 58 and 59 move with the first moveable frame. Movement of those sprockets relative to the fixed chains causes a translational movement of the chains relative to the sprockets, resulting in upward movement of the second moveable frame and attached load platform relative to the first moveable frame, equal to the movement of the first moveable frame relative to the fixed frame. The magnitude of the upward movement of the second moveable frame and load platform relative to the fixed frame is twice the magnitude of the movement of the first moveable frame relative to the fixed frame.

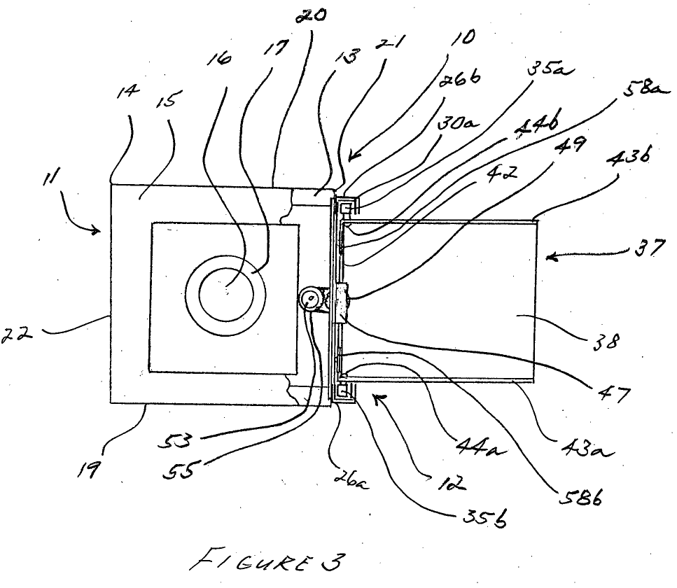

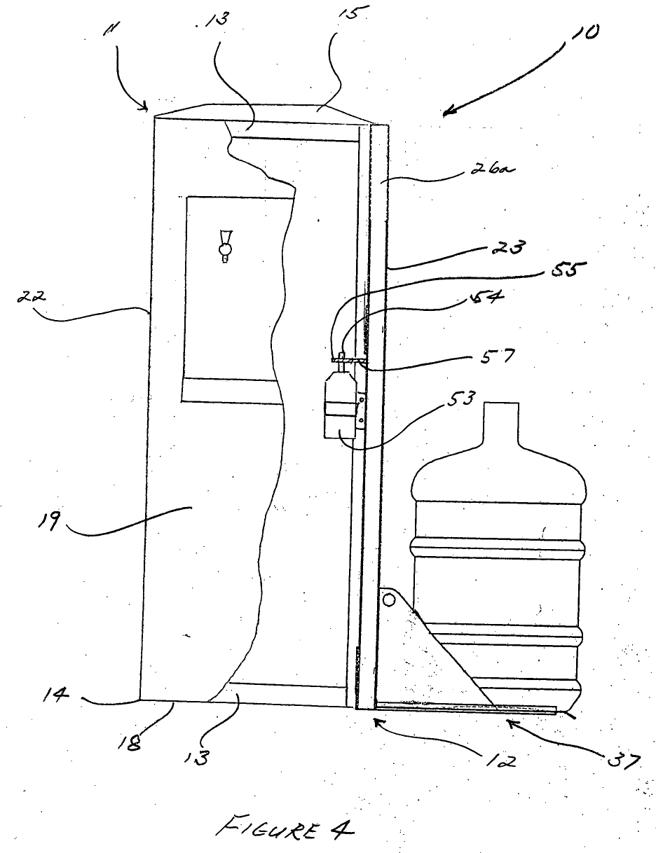

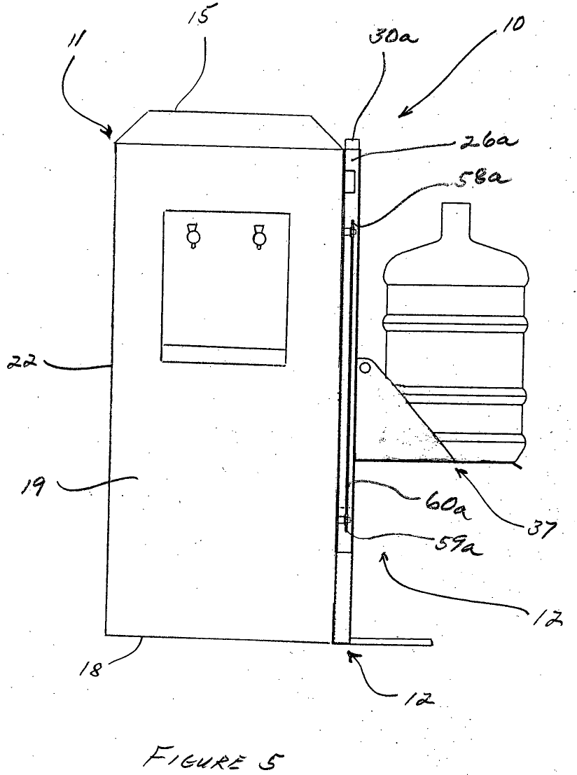

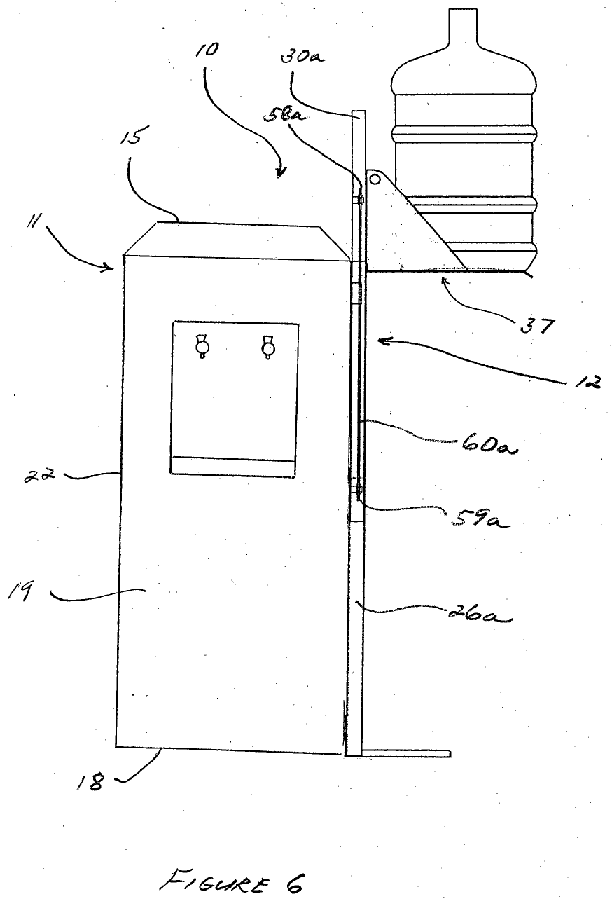

As a result of these relative movements, the second moveable frame and load platform, and a full water bottle placed thereon, moves through an intermediate position, shown in FIG. 3, to a final, fully elevated position shown in FIG. 4. At the fully elevated position the elevation of the base of the load platform is approximately equal to the elevation of the upper end of the fixed frame, slightly below the top 15 of the beverage dispenser housing. The load platform and the load it is carrying, can be rotated around pivot pins 45a and 45b through an angle of ninety degrees, as shown in FIG. 5, and toward an inverted orientation, as indicated in FIG. 6. Although not shown in the drawing figures, it will be readily understood that the load can be secured to the load platform by means such as clamps or straps to hold it in place until the securing means is released. After the water bottle is placed on the beverage dispenser, the load platform is rotated back to its original lifting orientation, and motor 53 is activated in reverse to lower the load platform to the starting point.

Although motor 53 may be deactivated manually when the load platform and load reach the upper limit of movement and the load is in position for inversion over the beverage dispenser, activated manually to lower the load platform, and deactivated manually when the load platform has reached the lower limit of movement, it is preferred that an upper limit switch 61 and a lower limit switch 62 be provided to automatically deactivate the motor at each end of the load platform travel, and to switch the polarity of the motor between each activation cycle. Although the specific placement of limit switches is not critical, such switches may be disposed on one of channels 26 of fixed frame 23.

The apparatus described above is susceptible to a number of variations and alternative embodiments within the scope of the invention. For example, although the use of an electric motor is preferred, it is to be understood that a pneumatic or a hydraulic motor could be used, if desired, within the scope of the invention.

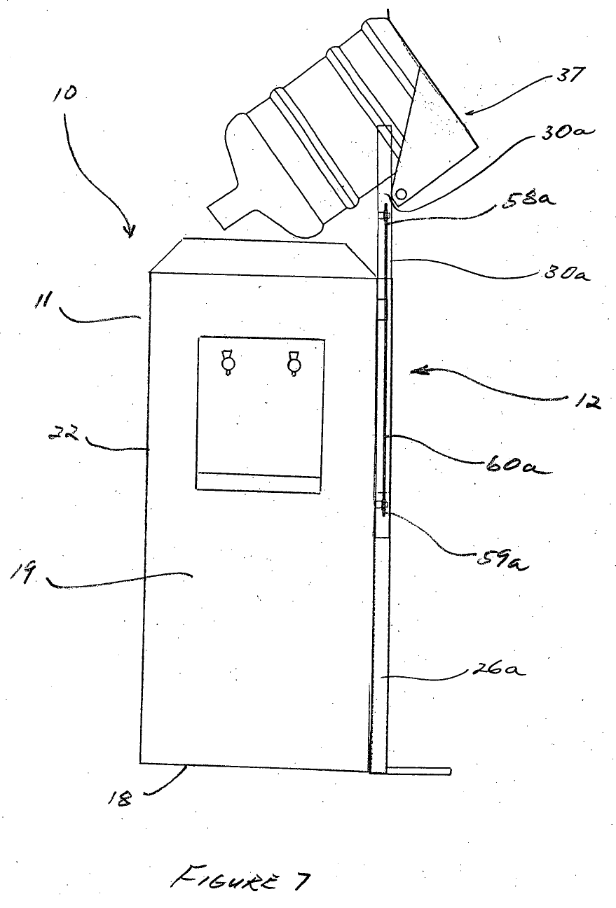

In an alternative embodiment illustrated in FIG. 7, the motor drive of the preferred embodiment is replaced by a manual drive. In this embodiment motor 53, sprocket 49, rod 46 and the associated thrust bearings 47 and 48 are omitted. An elongate toothed bar 63 is connected to horizontal braces 31 and 32 and extends parallel to and generally centered between upright channels 30a and 30b of the first moveable frame. The toothed bar is engaged by a gear wheel 64, which is mounted on an axle 65 extending across fixed frame 23 through mounting plates 66a and 66b on respective sides of the frame. An axle drive sprocket 67 is mounted on the outer end of axle 65, which extends outwardly a short distance from mounting plate 66a. A drive handle 68 is rotationally connected to a handle mounting plate 69 which is itself connected to channel 26a, or to an upper attachment bracket 29, and a handle sprocket 70 is connected to the handle near the mounting point.

A drive chain 71 extends around sprockets 67 and 70, so that rotation of the drive handle causes rotation of axle 65 and gear wheel 64 to drive the toothed bar 63. When handle 68 is turned, toothed bar 63 is caused to move up or down, depending on the direction of rotation of the handle. When bar 63 moves upward, it carries the first moveable frame with it, moving the first moveable frame upward relative to the fixed frame, with channels 30a and 30b sliding within channels 26a and 26b, respectively.

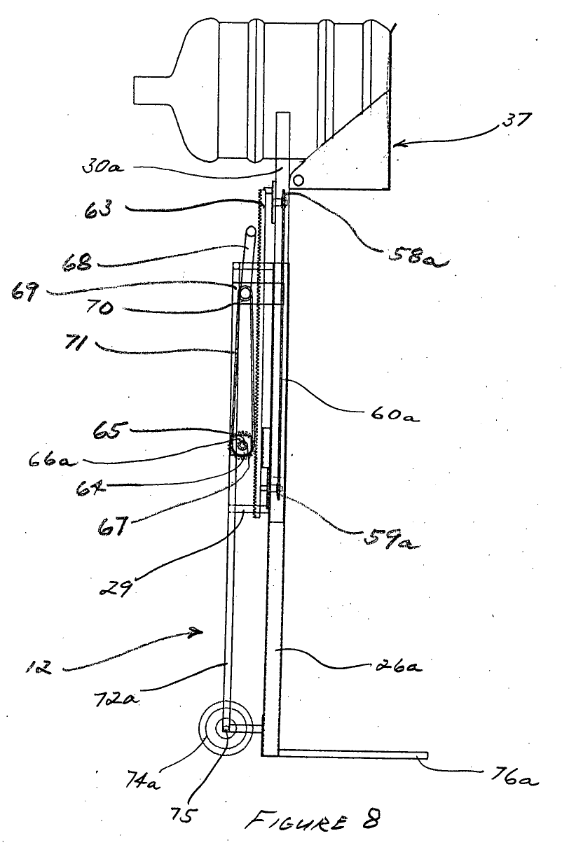

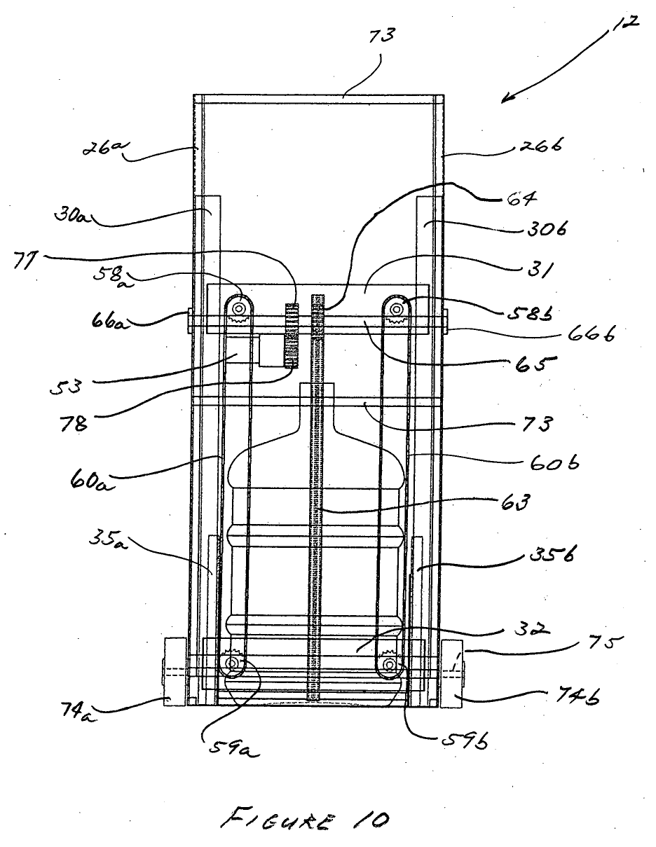

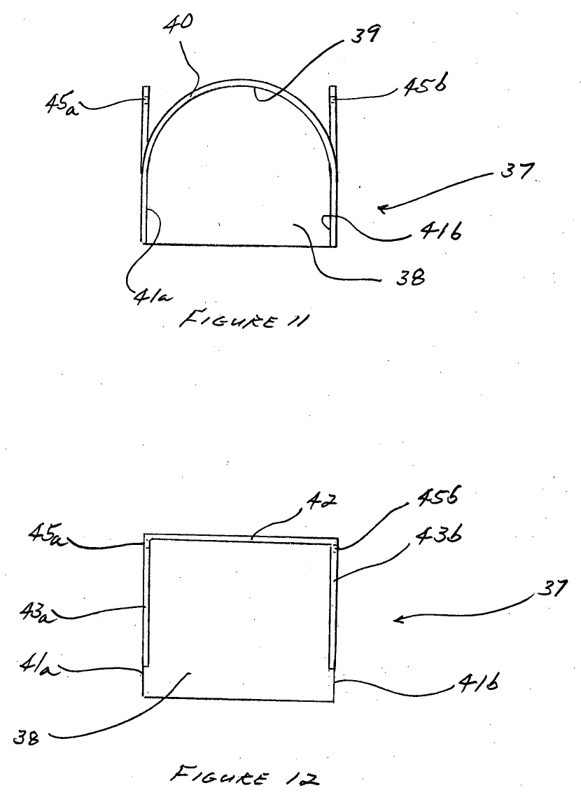

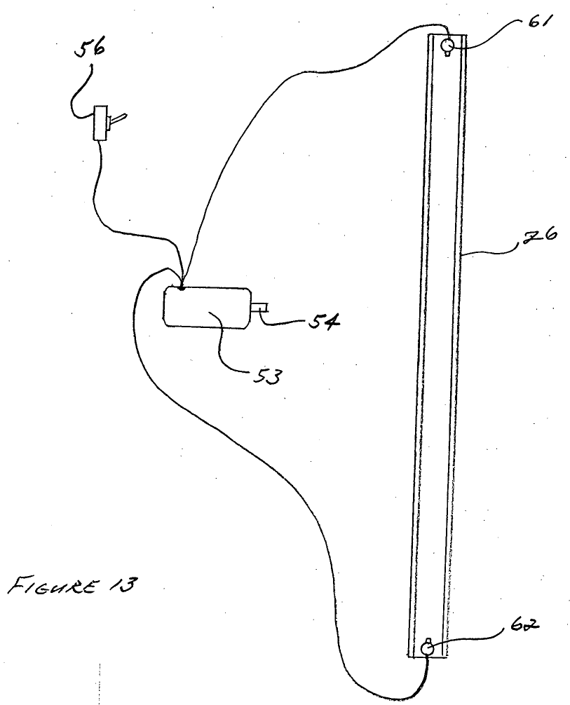

In another alternative embodiment, the lifting mechanism of the apparatus of the invention may be separated from the beverage dispenser and provided as an independent mobile load lifting and transferring apparatus, illustrated in FIGS. 8, 9, and 10. In this embodiment the manual crank drive described above is preferred for actuating the lifting mechanism to eliminate the need for an electrical power connection for operation of the apparatus, but a motor drive variation may also be used, as described below. In this embodiment a first fixed frame upright member 72a is disposed parallel to and connected to channel 26a, and a second fixed frame upright member 72b is disposed parallel to and connected to channel 26b. Brackets 29, used to connect channels 26 to a beverage dispenser frame in the preferred embodiment, may be used to form the connection between members 72 and channels 26. A plurality of cross braces 73 are connected between members 72a and 72b to reinforce and stabilize the fixed frame structure of the apparatus. It is preferred that three cross braces 73 be used, connected between members 72 at the top, bottom and middle of the fixed frame, but it is to be understood that neither the number nor the placement of cross braces is critical, and other configurations could be used if desired.

Mobility of the apparatus is provided by a pair of wheels 74a and 74b, connected to the fixed frame at the respective lower ends of rear uprights 72a and 72b. A wheel axle 75 preferably extends between wheels 74 through the interior of a brace 17 at that location if desired. A pair of load supports 76a and 76b are connected to the lower ends of upright channels 26a and 26b, respectively, and extend outwardly therefrom in perpendicular relation to the upright channels, and parallel to each other. The load supports provide a base for the frame of the apparatus and help support a load when the frame is tilted and rolled on wheels 74 to transport a load from place to place.

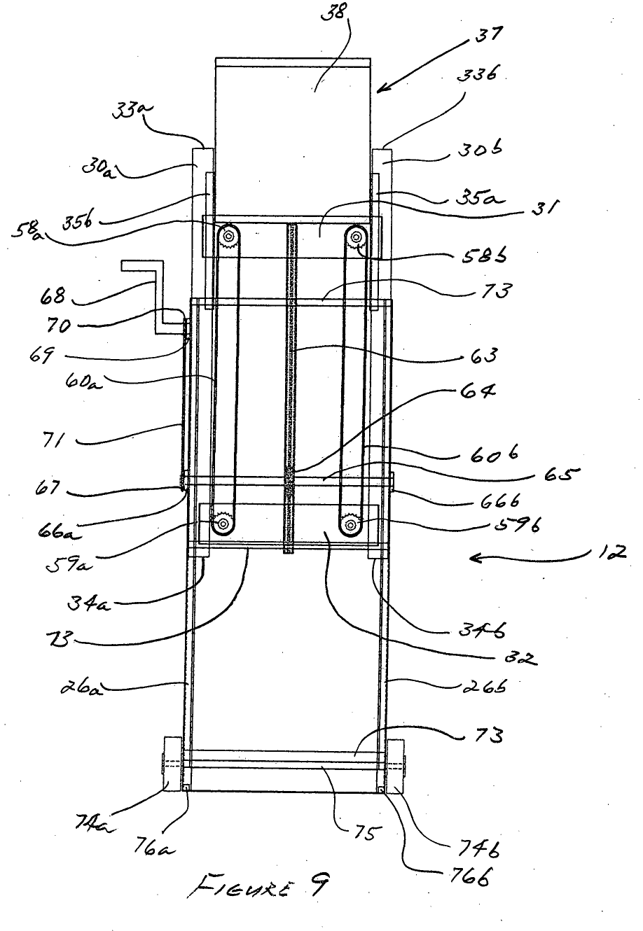

In a variation of the mobile embodiment of the lifting and transferring apparatus, illustrated in FIG. 9, a motor may be used as the drive means for the lift instead of a manually rotated handle. In this variation, handle 68, sprocket 67, chain 71, and associated components are omitted, and a motor 53 mounted to the fixed frame with the output shaft of the motor parallel to axle 65, to drive the axle and gear wheel 64 through gears 77 and 78, connected to the axle and the output shaft of the motor, respectively. It is contemplated that motor 53 in this embodiment would be a battery powered electric motor, but other types of motors could be used if desired. It will be understood that this motor driven embodiment of the alternative drive means may readily be used in the preferred, integrated dispenser and lifting mechanism apparatus, utilizing a toothed bar instead of a threaded rod, and replacing the drive components described in the context of that preferred embodiment with the drive components described immediately above.

In another variation, the screw driven drive means of the preferred embodiment may be utilized in the mobile lifting apparatus embodiment, with little change other than connecting motor 53 to the fixed frame of the mobile embodiment rather than to frame 13 of a beverage dispenser.

The foregoing description of preferred and alternative embodiments and variations of the apparatus of the invention is intended to be illustrative and not limiting. The apparatus of the is susceptible to other variations and alternative embodiments within the scope of the invention, in accordance with the full scope of the following claims.

1. Apparatus for lifting and transferring a water bottle to an integrated a beverage dispenser integrated with the lifting and transferring apparatus, comprising,
a beverage dispenser having a frame and a housing surrounding said frame and connected thereto, said housing having a top, a bottom, a rear panel, a front panel, and two opposed side panels, said top having an opening to receive a neck of a water bottle;
a fixed frame disposed adjacent to one of said side panels and parallel thereto, said fixed frame having a first upright channel extending substantially the full height of said side panel between said bottom and said top of said housing adjacent to the intersection of said side panel and said front panel and connected to said frame of said dispenser, and a second upright channel extending substantially the full height of said side panel between said bottom and said top of said housing adjacent to the intersection of said side panel and said rear panel and connected to said frame of said dispenser;
a first moveable frame slidably connected to said fixed frame such that said first moveable frame is moveable within said fixed frame between said first and second ends of said channels of said fixed frame, said first moveable frame having a third channel, with first and second ends, slidably connected to said first channel of said fixed frame, a fourth channel, with first and second ends, slidably connected to said second channel of said fixed frame, a first brace connected between said third channel and said fourth channel adjacent to said first ends thereof, and a second brace connected between said third channel and said fourth channel adjacent to said second ends thereof;
a second moveable frame slidably connected to said first moveable frame such that said second moveable frame is moveable within said first moveable frame between said first and second ends of said third and fourth channels of said first moveable frame, said second moveable frame having a fifth member slidably connected to said third channel of said first moveable frame, a sixth member slidably connected to said fourth channel of said first moveable frame, and a brace connected between said fifth member and said sixth member;
a load platform pivotally connected to said second moveable frame so as to move with said second moveable frame and to be rotatable relative to said second moveable frame, said load platform having a load bearing base;
a primary drive means for the purpose of moving said first moveable frame relative to said fixed frame; and
a secondary drive means for the purpose of moving said second moveable frame relative to said first moveable frame upon movement of said first moveable frame relative to said fixed frame.

2. The apparatus of claim 1, wherein said fixed frame further includes a bracket connected between said first and second upright channels in perpendicular relation thereto, and wherein said primary drive means comprises an elongate threaded rod disposed between said first and second channels of said first moveable frame and extending parallel thereto between said first brace and said second brace, said threaded rod fixedly connected to said first brace and to said second brace so as to prevent movement of said threaded rod relative to said first and second braces, a primary chain sprocket with a threaded central aperture threaded onto said threaded rod and disposed between said first and second braces, said chain sprocket rotatably connected to said bracket of said fixed frame so as to allow rotational movement of said, sprocket relative to said brace, a drive motor connected to said frame of said dispenser, said drive motor having a rotating output shaft with a drive sprocket connected thereto, with said drive sprocket in the same plane as said primary sprocket, and a looped drive chain engaged around said drive sprocket and said primary sprocket, such that rotation of said output shaft of said motor causes rotation of said primary sprocket on said threaded rod, thereby causing movement of said first moveable frame relative to said fixed frame.

3. The apparatus of claim 2, wherein said drive motor is an electric motor.

4. The apparatus of claim 3, wherein said primary drive means further includes a primary switch for activating and deactivating the operation of said motor, a first limit switch for deactivating said motor independently of said primary switch when said first ends of said third and fourth channels of said first moveable frame approach said first ends of said first and second channels of said fixed frame during movement of said first moveable frame, and a second limit switch for deactivating said motor independently of said primary switch when said second ends of said third and fourth channels of said first moveable frame approach said second ends of said first and second channels of said fixed frame during movement of said first moveable frame.

5. The apparatus of claim 1, wherein said fixed frame further includes a bracket connected between said first and second upright channels in perpendicular relation thereto, and wherein said second drive means comprises an upper secondary chain sprocket rotatably connected to said first brace of said first moveable frame, a lower secondary chain sprocket rotatably connected to said second brace of said first moveable frame, said upper and lower secondary sprockets lying in a plane parallel to said third and fourth channels of said first moveable frame, a looped secondary drive chain extending around said upper and lower secondary sprockets, said chain connected to said bracket of said fixed frame adjacent to said upper secondary sprocket, and said chain connected to said second moveable frame on the opposite side of said loop of said chain adjacent to said lower secondary sprocket, such that movement of said first moveable frame relative to said fixed frame causes movement of said second moveable frame in the same direction relative to said fixed frame and relative to said first moveable frame.

6. The apparatus of claim 5, wherein said secondary drive means further comprises a second upper secondary chain sprocket rotatably connected to said first brace of said first moveable frame, a second lower secondary chain sprocket rotatably connected to said second brace of said first moveable frame, said second upper and said second lower secondary sprockets lying in said plane, and a second looped secondary drive chain extending around said second upper and said second lower secondary sprockets, said second chain connected to said bracket of said fixed frame adjacent to said second upper secondary sprocket, and said second chain connected to said second moveable frame on the opposite side of said loop of said second chain adjacent to said second lower secondary sprocket.

7. The apparatus of claim 1, wherein said load platform comprises a substantially planar base with a rear edge and opposed side edges adjacent to said rear edge, and a support wall extending around said rear edge and said side edges of said base and connected thereto, with said support wall extending generally perpendicular to said base, said support wall pivotally connected to said fifth and sixth members of said second moveable frame distal from said connection of said support wall to said base.

8. The apparatus of claim 1, wherein said fixed frame further includes a bracket connected between said first and second upright channels in perpendicular relation thereto, and wherein said primary drive means comprises an elongate toothed bar disposed between said first and second channels of said first moveable frame and extending parallel thereto between said first brace and said second brace, said toothed bar fixedly connected to said first brace and to said second brace, an axle rotatably connected between said first and second channels of said fixed frame with said axle extending perpendicular to said toothed bar, a gear wheel fixedly connected to said axle and engaged with said toothed bar such that rotation of said axle and gear wheel induces longitudinal movement of said toothed bar, and a handle connected to said axle for causing rotation thereof.

9. The apparatus of claim 8, wherein said handle is connected to said fixed frame between said axle and said first ends of said channels of said fixed frame, and wherein said primary drive means further comprises an axle drive chain sprocket connected to said axle, a handle chain sprocket connected to said handle, and a looped chain engaged with said axle sprocket and said handle sprocket for transferring rotation of said handle to said axle.

10. The apparatus of claim 1, wherein said fixed frame further includes a bracket connected between said first and second upright channels in perpendicular relation thereto, and wherein said primary drive means comprises an elongate toothed bar disposed between said first and second channels of said first moveable frame and extending parallel thereto between said first brace and said second brace, said toothed bar fixedly connected to said first brace and to said second brace, an axle rotatably connected between said first and second channels of said fixed frame with said axle extending perpendicular to said toothed bar, a first gear wheel fixedly connected to said axle and engaged with said toothed bar such that rotation of said axle and gear wheel induces longitudinal movement of said toothed bar, a second gear wheel fixedly connected to said axle and separated from said first gear wheel, a drive motor having a rotating output shaft, disposed with said output shaft parallel to said axle, and a third gear wheel fixedly connected to said output shaft and in engagement with said second gear wheel.

11. The apparatus of claim 1, wherein said first and second channels of said fixed frame comprise C-channels each having three closed sides surrounding an open interior, and one open side, with said first and second channels disposed with said open sides facing each other, wherein said third and fourth channels of said first moveable frame comprise C-channels each having three closed sides surrounding an open interior, and one open side, with said third and fourth channels of said first moveable frame disposed in said first and second channels of said fixed frame, respectively, with said open sides of said third and fourth channels facing each other, and wherein said fifth and sixth members of said second moveable frame comprise four sided closed members, with said fifth and sixth members disposed in said third and fourth channels of said first moveable frame, respectively.

12. An integrated beverage dispenser and water bottle lifting and transferring apparatus, comprising,
a beverage dispenser having a frame and a housing surrounding said frame and connected thereto, said housing having a top, a bottom, a rear panel, a front panel, and two opposed side panels, said top having an opening to receive a neck of a water bottle;
a fixed frame disposed adjacent to one of said side panels and parallel thereto, said fixed frame having a first upright channel with one open side, extending substantially the full height of said side panel between said bottom and said top of said housing adjacent to the intersection of said side panel and said front panel and connected to said frame of said dispenser, a second upright channel with one open side, extending substantially the full height of said side panel between said bottom and said top of said housing adjacent to the intersection of said side panel and said rear panel and connected to said frame of said dispenser, with said open sides of said first and second channels facing each other, and a bracket connected between said first and second channels in generally perpendicular relation thereto;
a first moveable frame slidably connected to said fixed frame such that said first moveable frame is moveable within said fixed frame between said first and second ends of said channels of said fixed frame, said first moveable frame having a third channel, with first and second ends and with one open side, slidably nested in said first channel of said fixed frame, a fourth channel, with first and second ends and an open side, slidably nested in said second channel of said fixed frame, a first brace connected between said third channel and said fourth channel adjacent to said first ends thereof, and a second brace connected between said third channel and said fourth channel adjacent to said second ends thereof;
a second moveable frame slidably connected to said first moveable frame such that said second moveable frame is moveable within said first moveable frame between said first and second ends of said third and fourth channels of said first moveable frame, said second moveable frame having a fifth member slidably nested in said third channel of said first moveable frame, a sixth member slidably nested in said fourth channel of said first moveable frame, and a brace connected between said fifth member and said sixth member;
a load platform pivotally connected to said second moveable frame so as to move with said second moveable frame and to be rotatable relative to said second moveable frame, said load platform having a load bearing base;
a primary drive means for the purpose of moving said first moveable frame relative to said fixed frame; and
a secondary drive means for the purpose of moving said second moveable frame relative to said first moveable frame upon movement of said first moveable frame relative to said fixed frame.

13. The integrated beverage dispenser and water bottle lifting and transferring apparatus of claim 12, wherein said primary drive means comprises an elongate threaded rod disposed between said first and second channels of said first moveable frame and extending parallel thereto between said first brace and said second brace, said threaded rod fixedly connected to said first brace and to said second brace so as to prevent movement of said threaded rod relative to said first and second braces, a primary chain sprocket with a threaded central aperture threaded onto said threaded rod and disposed between said first and second braces, said chain sprocket rotatably connected to said bracket of said fixed frame so as to allow rotational movement of said sprocket relative to said brace, a drive motor connected to said frame of said dispenser, said drive motor having a rotating output shaft with a drive sprocket connected thereto, with said drive sprocket in the same plane as said primary sprocket, and a looped drive chain engaged around said drive sprocket and said primary sprocket, such that rotation of said output shaft of said motor causes rotation of said primary sprocket on said threaded rod, thereby causing movement of said first moveable frame relative to said fixed frame.

14. The integrated beverage dispenser and water bottle lifting and transferring apparatus of claim 13, wherein said drive motor is a reversible electric motor disposed within said housing of said dispenser and connected to said frame of said dispenser.

15. The integrated beverage dispenser and water bottle lifting and transferring apparatus of claim 14, wherein said primary drive means further includes a primary switch for activating and deactivating the operation of said motor, a first limit switch for deactivating said motor independently of said primary switch when said first ends of said third and fourth channels of said first moveable frame approach said first ends of said first and second channels of said fixed frame during movement of said first moveable frame, and a second limit switch for deactivating said motor independently of said primary switch when said second ends of said third and fourth channels of said first moveable frame approach said second ends of said first and second channels of said fixed frame during movement of said first moveable frame.

16. The integrated beverage dispenser and water bottle lifting and transferring apparatus of claim 12, wherein said secondary drive means comprises a first upper secondary chain sprocket rotatably connected to said first brace of said first moveable frame adjacent to said first channel of said fixed frame, a first lower secondary chain sprocket rotatably connected to said second brace of said first moveable frame adjacent to said first channel of said fixed frame, a second upper secondary chain sprocket rotatably connected to said first brace of said first moveable frame adjacent to said second channel of said fixed frame, a second lower secondary chain sprocket rotatably connected to said second brace of said first moveable frame adjacent to said second channel of said fixed frame, said upper and lower secondary sprockets mutually lying in a plane parallel to said third and fourth channels of said first moveable frame, a first looped secondary drive chain extending around said upper and lower secondary sprockets, said first chain connected to said bracket of said fixed frame adjacent to said first upper secondary sprocket, and said first chain connected to said second moveable frame on the opposite side of said loop of said first chain adjacent to said first lower secondary sprocket, and a second looped secondary drive chain extending around said second upper and second lower secondary sprockets, said second chain connected to said bracket of said fixed frame adjacent to said second upper secondary sprocket, and said second chain connected to said second moveable frame on the opposite side of said loop of said second chain adjacent to said second lower secondary sprocket.

17. A lifting and transferring apparatus for lifting a load along a front side of the apparatus and rotating the load over the top of the apparatus toward an inverted orientation on the rear side of the apparatus, comprising,
a fixed frame having elongate first and second upright members each having a first end and a second end, disposed in parallel separated relation and connected to each other, an elongate first upright channel having a first end and a second end, disposed in parallel separated relation to said first upright member and connected thereto, a second upright channel having a first end and a second end, disposed in parallel separated relation to said second upright member and connected thereto, a bracket connected between said first and second upright channels in generally perpendicular relation thereto, a pair of load supports each connected to the said second end of a respective one of said first and second channels and extending outwardly therefrom away from said upright members in generally parallel relation to each other and in generally perpendicular relation to said channels;
a first moveable frame slidably connected to said fixed frame such that said first moveable frame is moveable within said fixed frame between said first and second ends of said channels of said fixed frame, said first moveable frame having a third channel, with first and second ends, slidably connected to said first channel of said fixed frame, a fourth channel, with first and second ends, slidably connected to said second channel of said fixed frame, a first brace connected between said third channel and said fourth channel adjacent to said first ends thereof, and a second brace connected between said third channel and said fourth channel adjacent to said second ends thereof;
a second moveable frame slidably connected to said first moveable frame such that said second moveable frame is moveable within said first moveable frame between said first and second ends of said third and fourth channels of said first moveable frame, said second moveable frame having a fifth member slidably connected to said third channel of said first moveable frame, a sixth member slidably connected to said fourth channel of said first moveable frame, and a brace connected between said fifth member and said sixth member;
a load platform pivotally connected to said second moveable frame and disposed above said load supports of said fixed frame, so as to move with said second moveable frame and to be rotatable relative to said second moveable frame, said load platform having a load bearing base;
a primary drive means for the purpose of moving said first moveable frame relative to said fixed frame; and
a secondary drive means for the purpose of moving said second moveable frame relative to said first moveable frame upon movement of said first moveable frame relative to said fixed frame.

18. The lifting and transferring apparatus of claim 17, wherein said primary drive means comprises an elongate toothed bar disposed between said first and second channels of said first moveable frame and extending parallel thereto between said first brace and said second brace, said toothed bar fixedly connected to said first brace and to said second brace, an axle rotatably connected between said first and second members of said fixed frame with said axle extending perpendicular to said toothed bar, a gear wheel fixedly connected to said axle and engaged with said toothed bar such that rotation of said axle and gear wheel induces longitudinal movement of said toothed bar, and a handle connected to said axle for causing rotation thereof.

19. The lifting and transferring apparatus of claim 17, wherein said secondary drive means comprises a first upper secondary chain sprocket rotatably connected to said first brace of said first moveable frame adjacent to said first channel of said fixed frame, a first lower secondary chain sprocket rotatably connected to said second brace of said first moveable frame adjacent to said first channel of said fixed frame, a second upper secondary chain sprocket rotatably connected to said first brace of said first moveable frame adjacent to said second channel of said fixed frame, a second lower secondary chain sprocket rotatably connected to said second brace of said first moveable frame adjacent to said second channel of said fixed frame, said upper and lower secondary sprockets mutually lying in a plane parallel to said third and fourth channels of said first moveable frame, a first looped secondary drive chain extending around said upper and lower secondary sprockets, said first chain connected to said bracket of said fixed frame adjacent to said first upper secondary sprocket, and said first chain connected to said second moveable frame on the opposite side of said loop of said first chain adjacent to said first lower secondary sprocket, and a second looped secondary drive chain extending around said second upper and second lower secondary sprockets, said second chain connected to said bracket of said fixed frame adjacent to said second upper secondary sprocket, and said second chain connected to said second moveable frame on the opposite side of said loop of said second chain adjacent to said second lower secondary sprocket.

20. The lifting and transferring apparatus of claim 17, wherein said load platform comprises a substantially planar base with a rear edge and opposed side edges adjacent to said rear edge, and a support wall extending around said rear edge and said side edges of said base and connected thereto, with said support wall extending generally perpendicular to said base, said support wall pivotally connected to said fifth and sixth members of said second moveable frame distal from said connection of said support wall to said base, such that said load platform is rotatable about said pivotal connections through a range of approximately one hundred eighty degrees over said first ends of said first and second channels and said first and second upright members of said fixed frame with said first moveable frame and said second moveable frame positioned at said first ends of said first and second channels.

21. The apparatus of claim 17, further comprising a pair of wheels connected, respectively, to said second ends of said first and second upright members for the purpose of facilitating transporting of the apparatus with or without a load thereon.
